(19) United States
(12) Patent Application Publication
(10) Pub. No.: US 2012/0145847 A1
(43) Pub. Date: Jun. 14, 2012

(54) HOOK

(75) Inventor: Guang-He Wang, Dongguan City (CN)

(73) Assignee: DONG GUAN REN-RIVER RUBBER PRODUCTS CO., LTD., Dongguan City, Guangdong Province (CN)

(21) Appl. No.: 13/390,689

(22) PCT Filed: Sep. 11, 2010
(86) PCT No.: PCT/CN10/76820

§ 371 Date: Feb. 15, 2012

(30) Foreign Application Priority Data
Sep. 11, 2009 (CN) 200920204723.8

(51) Int. Cl. F16B 45/00; F16B 47/00

(52) U.S. Cl. 248/205.3

(57) ABSTRACT

A hook comprises an adhesive body and a hook body attached to the adhesive body, where the adhesive body comprises a base layer and an adhesive layer. The adhesive layer is a thermoplastic elastomer with an intrinsic adhesion. The hook body and the adhesive layer are respectively attached to two opposite surfaces of the base layer. The hook includes a base layer interposed between the hook body and the adhesive layer, so that the hook body is not directly attached to the adhesive layer. While in use, the adhesive layer isn't directly pulled by the object, thus the adhesive layer has prolonged service life and enhanced adhesive intensity. Besides, through setting the base layer, the hook has better tenacity, and various needed patterns, colors or textures are easily printed on the base layer.

### FIELD

The present invention relates to a device for fixing articles, and more especially to a hook for fixing object by an adhesion means.

### BACKGROUND

Some devices for fixing articles are seen around daily works and family lives, wherein hooks are most widely used. The hooks mainly include two different types.

One is an adhesive type, which uses a glue or plastic to fix on a wall and the likes by adhesiveness. Taking a sticker hook as a typical example, it includes a sticker and a hook body attached to the sticker. The sticker has a relatively large surface area. The sticker with large surface area is attached to the wall and forms an airtight effect. The sticker is forced to be pulled away from the wall, and then a certain vacuum is formed therebetween, when the hook body hangs an object. Thus, the hook body can support an object with a certain weight due to an atmosphere pressure action. This sticker hook is a one-off product and adhesiveness of the sticker becomes weakened while being moved, thereby requiring no removal. Besides, a certain adhesive remains stays on the wall after the hook is out of work.

The other is a vacuum suction type hook, which generally uses a sucker attached to the wall to achieve a desired fixation and support for an object. However, the sucker has a relatively small weight load and is usually adapted for only even wall surfaces rather than for ordinary walls or wood walls with rough surfaces. Further, material of the sucker is easy to become weary and aging after a long work, accordingly decreasing working life.

### SUMMARY

Therefore, an adhesive type of hook is provided, which has a firm fixation and a variety of applications.

A hook comprises an adhesive body and a hook body attached to the adhesive body. The adhesive body comprises a base layer and an adhesive layer. The hook body and the adhesive layer are attached to two opposite surfaces of the base layer respectively.

The above-described hook has a base layer between the hook body and the adhesive layer to avoid that the hook body is directly attached to the adhesive layer. As such, object does not generate a direct pulling force to the adhesive layer in practical application to increase working life of the adhesive layer and enhance adherent intensity. As a result, the hook can firmly support the object. Besides, by means of using the base layer, flexibility of the hook can be enhanced. The hook is not easy to be transformed and has a good tensile and a good aging resistance. Further, a variety of desired patterns, colors, or textures can be readily printed on the base layer, thereby bringing out various wide applications and good practicability.

### BRIEF DESCRIPTION OF DRAWINGS

The embodiments of the present invention is described in detail with reference to the drawings, wherein:

FIG. 1 is an isometric, schematic view of a hook in accordance with a first embodiment of the present invention;

FIG. 2 is a side, schematic view of the hook in accordance with the first embodiment of the present invention;

FIG. 3 is an isometric, schematic view of a hook in accordance with a second embodiment of the present invention.

FIG. 4 is a disassembled, schematic view of a hooking portion of the hook in accordance with the second embodiment of the present invention;

FIG. 5 is an isometric, schematic view of a hook in accordance with a third embodiment of the present invention; and

FIG. 6 is a disassembled, schematic view of a hooking portion of the hook in accordance with the third embodiment of the present invention.

### DETAILED DESCRIPTION

In order to make clearer the objects, technical solutions and advantages of the invention, the present invention will be explained below in detail with reference to the accompanying drawings and embodiments. It is to be understood that the following description of the embodiments is merely to explain the present invention and is no way intended to limit the invention.

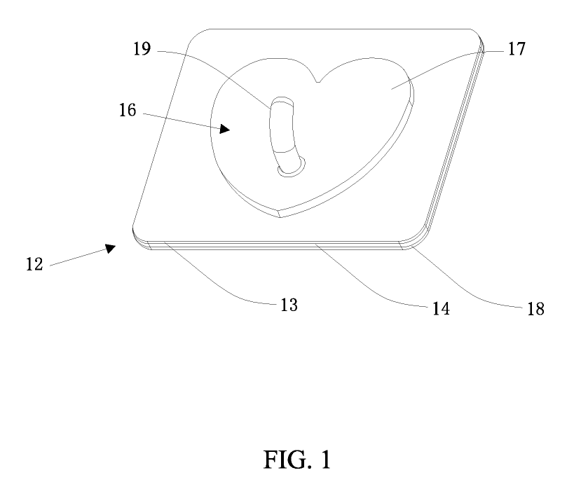

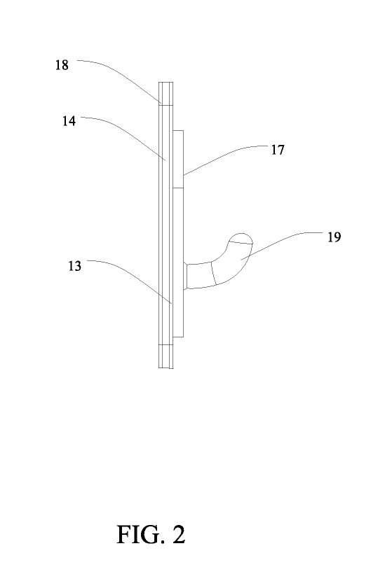

FIGS. 1 and 2 show a hook 10 according to a first embodiment of the present invention, which includes an adhesive body 12 and a hook body 16 attached to the adhesive body 12. The adhesive body 12 comprises a base layer 13 and an adhesive layer 14. The hook body 16 and the adhesive layer 14 are attached to two opposite surfaces of the base layer 13 respectively. The adhesive body 12 has a surface area larger than an area where it is in contact with the hook body 16.

Wherein, the base layer 13 may include a polypropylene film, a polycarbonate film, a polyethylene film, a polyethylene terephthalate film, a cloth, a leather and a synthetic paper. The adhesive layer 14 inherently has a flexible property such that the hook 10 can be suspended on a curved, rough or rugged surface, even very rough or seriously rugged surface. It is to be understood that the base layer 14 could be a film or sheet with a certain pliable and tough, for example, a metal sheet. In practical application, the base layer 14 could include at least one of a polypropylene film, a polycarbonate film, a polyethylene film, a polyethylene terephthalate film, a cloth, a leather and a synthetic paper.

The adhesive layer 14 may be thermoplastic elastomer, preferably styrene thermoplastic elastomer, for example, TPE (Thermo plastic elastomer), TPR (Thermo plastic rubber), or styrene-butadiene styrene block copolymer (SBS) and so on. The adhesive layer preferably includes the following compositions by weight: 100 parts styrene-ethylene-butadiene styrene (SEBS) block copolymer, 100-300 parts hydrogenated naphthenic oil, 100-300 parts white oil, 0-10 parts petroleum adhesion promoter resin, 1-5 parts polypropylene resin, 2-10 parts assistant agent. Wherein, SEBS may be a G or D series product from Kraton Company in American, or an YH series product from Balin Huaxing Petrochemical Ltd. in Yueyang, China. The hydrogenated naphthenic oil preferably occupies 150-300 parts, more preferably 200-280 parts. The hydrogenated naphthenic oil acts as filling oil, may be KNH or NK series naphthenic oil from Petrochina Karamay Petrochemical Company. For example, the hydrogenated naphthenic oil may be made by hydrogenising and furfural caly refining an atmospheric distillate of a naphthenic crude oil, then blending with an antioxidant. The white oil cooperates with the naphthenic oil. The white oil preferably occupies 150-300 parts, more preferably 200-280 parts. The petroleum adhesion promoter resin could be, e.g., four series products of C₉ petroleum resin, C₅ petroleum resin, C₅/C₉ copolymer petroleum resin, dicyclopentadiene (DCPD) petroleum resin, and is made of raw material mainly including C₅, C₉ fractions. The petroleum adhesion promoter resin preferably occupies 1-10 parts, more preferably 3-8 parts. The added polypropylene resin can improve modulus and hardness of product. The assistant agent includes but not limited to plasticizer (e.g., paraffin or polyethylene oligomer), antioxidant (e.g., calcium carbonate or silica micro powder), photostabilizer and ultraviolet stabilizer (e.g., UV-P and UV-320) and so on. The assistant agent preferably occupies 4-8 parts, for plasticizing, anti-oxidation, anti-aging, improving light stability and ultraviolet stability. Wherein hardness and surface viscidity depend on content of the filling oil, accordingly, content of adhesion promoter resin can be decreased. Thus, it is much convenient to clean up dirt adherent to the surface of the adhesive layer and accordingly maintain the properties of the product during working period of the hook.

As required by the properties of the hook, the adhesive layer 14 with the formulas mentioned above can possess an excellent adhesion intensity and hardness. For example, the hook can firmly adhered to the wall and the likes and it is adapted to be reused, has a relatively longer working life, and is substantially able to use again after being torn off without loss of viscidity.

Advantageously, the adhesive layer has a surface adhesion intensity in a range of 0.1-0.6 N/cm, a thickness in a range of 0.1-2.0 mm, a shore A hardness in a range of 0-20. The adhesive layer 14 is bonded to the base layer 13 by a hot-melt injection or coating. The base layer 13 may be pretreated prior to bonding with the adhesive layer 14, and further may be formed with a variety of patterns, colors or textures. This thermoplastic elastomer adhesive layer 14 can be reused many times without loss of its viscidity, since it is adhered to the wall and the likes with itself inherent adhesion of the thermoplastic elastomer material instead of binder. Further, the adhesive layer 14 can maintain its adhesion intensity after being removed and its adhesion intensity is substantially not decreased after a long working period and being frequently removed and reused, thereby prolonging working life of the hook. No adhesive material remains stays on the region where the adhesive layer is bonded, accordingly providing a lot of convenience for user. Besides, such a thermoplastic elastomer facilitates washing of dirt or impurity on the surface of the thermoplastic elastomer. It is easy to clean up or remove off the dirt or impurity, after all, the dirt or impurity is just adsorbed on the surface of the thermoplastic elastomer rather than being stuck thereon as happened in the art.

Referring to FIG. 2, a protective film 18 covers on an outer surface of the adhesive layer 14. The protective film 18 includes a plastic film or paper layer and a releasing layer. The releasing layer is attached to a surface of the plastic film or paper layer which the adhesive layer 14 comes into contact with to facilitate removal of the protective layer 18 from the adhesive layer 14. The protective layer 18 may use polyethylene terephthalate (PET), polypropylene (PP), polyethylene (PE), all kinds of papers and so on. The protective layer 18 is used to decrease contamination to product resulting from manual manipulation and to ensure a good quality of the product. For example, the protective layer 18 can protect the adhesive layer 14 during packaging, transporting, or in idle period, and then is removed off in use to support object with adhesion of adhesive layer 14.

The hook body 16 includes a fixing portion 17 and a hooking portion 19. The fixing portion 17 is attached to the base layer 13, for example, with an adhesive. The hook body 16 could be made of a material selected from a group consisting of plastic, synthetic plastic, hardware, wood, ceramic, rubber and any combinations thereof. Generally, different materials of the hook body 16 are adapted to be bonded to various base layers 13 by using various adhesive materials. The fixing portion 17 has an even surface which is attached to the base layer 13 to enhance adhesion intensity therebetween. The fixing portion 17 and the hooking portion 19 could be configured as a whole as shown in FIGS. 1 and 2, or in a detachable form. If in an integral form, the fixing portion 17 and the hooking portion 19 are formed as a monolithic structure by an integrated molding. If in a detachable form, the fixing portion 17 and the hooking portion 19 are bonded together with various detachable means. Such a detachable means has some advantages in that, on one hand, the hooking portion 19 is readily replaced when it get worn or breakage, on the other hand, the hooking portion 19 is removable for washing. Furthermore, the hooking portion 19 is able to be taken off to hook an object, and then the hooking portion 19 with the object hooked is installed back to the fixing portion 17. As such, it is benefit for suspending some object which is not readily and directly hung up to the hook 10 on the wall.

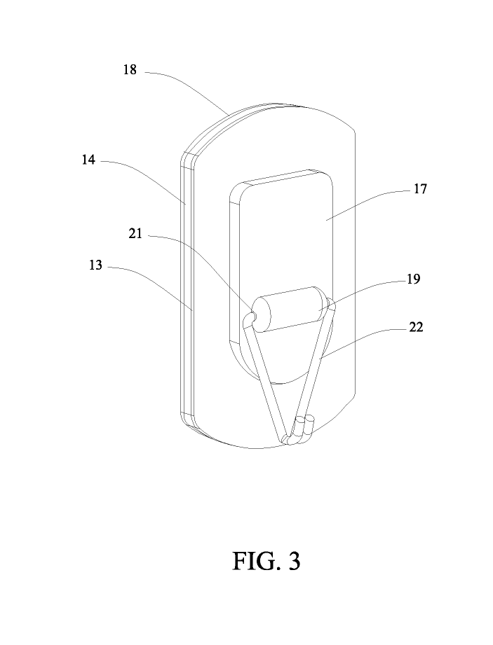

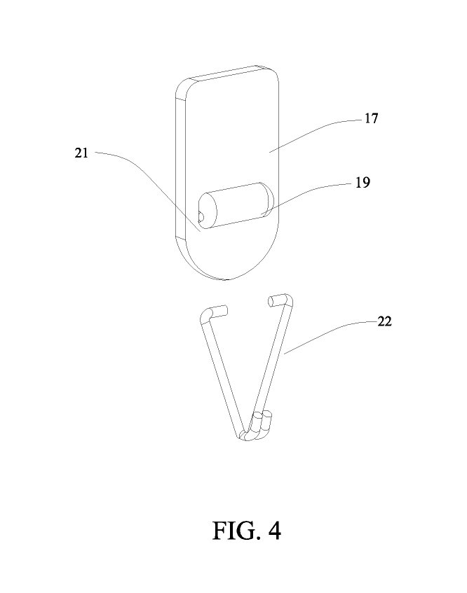

FIGS. 3 and 4 show a hook 20 according to a second embodiment of the present invention. The hook 20 is essentially similar to the hook 10 according to the first embodiment expect of an engagement means between the fixing portion 17 and the hooking portion 19. Wherein, the same components in the FIGS. 3 and 4 to those in FIGS. 1 and 2 are designated as identical reference numbers, without repeating what has been so lately described.

For the hook 20 according to the second embodiment, the fixing portion 17 and the hooking portion 19 are connected with a snap mechanism, as shown, the snap mechanism includes grooves 21 defined in the fixing portion 17 and projections 22 disposed at the hooking portion 19. Two grooves 21 are illustrated in the drawings, which are defined in both ends of a column lying on the fixing portion 17. The hooking portion 19 is a resilient clip and has two opposite clip ends which act as the projections 22. In use, the projections 22 are inserted into the grooves 21 and snap into the grooves 21 due to a resilient force. When disassembling, the projections 22 are directly drawn out of the grooves 21.

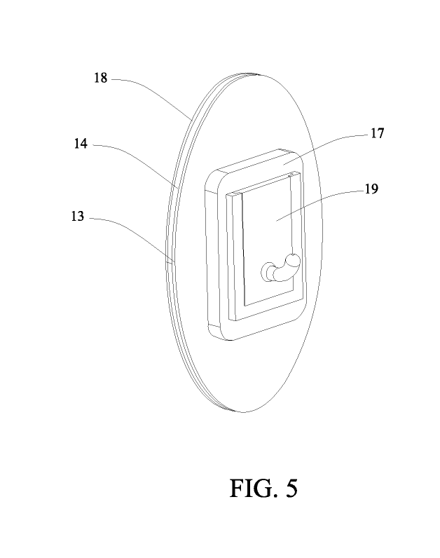

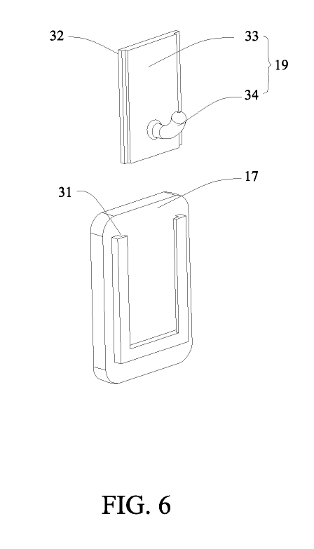

FIGS. 5 and 6 show a hook 30 according to a third embodiment of the present invention. The hook 30 is essentially similar to the hook 20 according to the second embodiment expect of an engagement means between the fixing portion 17 and the hooking portion 19. Wherein, the same components in the FIGS. 5 and 6 to those in FIGS. 1 and 2 are designated as identical reference numbers, without repeating what has been so lately described.

According to the third embodiment, the fixing portion 17 and the hooking portion 19 are connected with an pluggable connection means, as shown in FIG. 5, the hooking portion 19 includes an insertion plate 33 and a hanger 34 disposed on the insertion plate 33. The pluggable connection means includes sliding grooves 31 defined in the fixing portion 17 and slides 32 disposed on the insertion plate 33. It is apparently understood that the sliding grooves 31 and the slides 32 can transpose, namely are correspondingly disposed on the insertion plate 33 and the fixing portion 17. The sliding grooves 31 are open at both upper ends and are close at both lower ends which form stop portions for facilitating fixation of the slides 32 into the sliding grooves 31. The slides 32 could be a flange extending from edges of the insertion plate 33 and are thinner than the insertion plate 33, or alternatively are just the edges of the insertion plate 33. Besides, the slides 32 are not limited to those structure described above. When using, object is firstly hung onto the hanger 34 and then the slides 32 slide into the sliding grooves 31, accordingly achieving suspension of object. Alternatively, to achieve suspension of object, it is possible that the hanger 34 is firstly fixed onto the fixing portion 17 through the slides 32, and then object is hung onto the hanger 34. When detaching, the fixing portion 17 and the hooking portion 19 are freely departed from each other by directly sliding away the insertion plate 33.

Additionally, it is understood that detachable connection of the fixing portion 17 and the hooking portion 19 is not limited to embodiments mentioned above which are illustrated as examples but are not limitative.

For the hook according to these embodiments described above, a base layer 13 is interposed between the hook body 16 and the adhesive layer 14, and so it is not necessary that the hook body 16 is directly bonded to the adhesive layer 14. As such, the adhesive layer 14 is not subjected to a direct draw from the object, thereby enhancing working life of the adhesive layer 14 and increasing adhesion intensity thereof. Accordingly, the hook can firmly support the object. Besides, with the base layer 14 interposed between the adhesive layer 14 and the hook body 16, the hook has an enhanced flexibility, is not easy to transformed and has a good anti-aging and tensile properties. A variety of desired patterns, colors, or textures are readily printed on the base layer 14, thereby bringing out merits like various wide applications and good practicability.

Furthermore, according to above embodiments, these detachable connections facilitate use, clean, placing and picking of the hooking portion. Further, the hooking portion 19 is able to be departed, and the fixing portion 17 and the adhesive body 12 are kept to be fixed on the wall, thereby improving application convenience.

The above-mentioned is only the preferred embodiments of the present invention, but places no limit to the present invention. Therefore, any modification, equivalent replacement and improvement etc on the basis of the spirit and principle of the present invention shall be within the protective scope of the present invention.

What is claimed is:

1. A hook comprising:
an adhesive body; and
a hook body attached to the adhesive body;
wherein the adhesive body comprises a base layer and an adhesive layer, and the hook body and the adhesive layer are attached to two opposite surfaces of the base layer respectively.

2. The hook as claimed in claim 1, wherein the adhesive layer is made of styrenicthermo plastic elastomer.

3. The hook as claimed in claim 1, wherein the adhesive layer comprises the following compositions by weight: 100 parts styrene-ethylene-butadiene styrene block copolymer, 100-300 parts hydrogenated naphthenic oil, 100-300 parts white oil, 0-10 parts petroleum adhesion promoter resin, 1-5 parts polypropylene resin, 2-10 parts assistant agent.

4. The hook as claimed in claim 1, wherein the adhesive layer has a surface adhesion intensity in a range of 0.1-0.6 N/cm, a thickness in a range of 0.1-2.0 mm, a shore A hardness in a range of 0-20.

5. The hook as claimed in claim 1, wherein a protective film which is removable when using covers on an outer surface of the adhesive layer.

6. The hook as claimed in claim 1, wherein the adhesive body has a surface area larger than an area where the adhesive layer is in contact with the hook body.

7. The hook as claimed in claim 1, wherein the base layer comprises at least one of a polypropylene film, a polycarbonate film, a polyethylene film, a polyethylene terephthalate film, a cloth, a leather and a synthetic paper.

8. The hook as claimed in claim 1, wherein the hook body includes a fixing portion attached to the base layer and a hooking portion, the hook body and the fixing portion being configured as a whole or in a detachable form.

9. The hook as claimed in claim 8, wherein the hook body and the fixing portion in a detachable form are detachably connected with a snap means or a pluggable connection means.

10. The hook as claimed in claim 8, wherein a surface of base layer is provided with patterns, colors or textures.
